(19) United States
(12) Patent Application Publication
(10) Pub. No.: US 2026/0299525 A1
(43) Pub. Date: Oct. 1, 2026

(54) SERVER, CONTROL METHOD, AND PROGRAM

(71) Applicant: NEC Corporation, Tokyo (JP)

(72) Inventors: Norihito OI, Tokyo (JP); Kazuhiro YANASE, Tokyo (JP)

(73) Assignee: NEC Corporation, Tokyo (JP)

(21) Appl. No.: 19/630,720

(22) Filed: Mar. 27, 2026

(30) Foreign Application Priority Data
Apr. 1, 2025 (JP) 2025-060768

(51) Int. Cl. G05B 13/02; E02B 9/00

(52) U.S. Cl. CPC G05B 13/0265; E02B 9/00

(57) ABSTRACT

A server includes a marine environment information reception part that receives marine environment information detected by each sensor, a marine environment information transmission part that transmits the received marine environment information to a control instruction generation apparatus, a control instruction information reception part that receives marine environment control instruction information generated by the control instruction generation apparatus based on the transmitted marine environment information, and a control instruction information transmission part that transmits the received marine environment control instruction information to each control apparatus.

### FIELD

The present invention is based upon and claims the benefit of the priority of Japanese patent application No. 2025–060768 filed on Apr. 1, 2025, the disclosure of which is incorporated herein in its entirety by reference thereto.

The present invention relates to a server, a control method, and a program.

### BACKGROUND

The following literature can be cited regarding a system that acquires information on the natural environment of an offshore wind power generation facility and the surrounding underwater or sea surface.

Patent Literature 1 relates to an offshore wind farm that acquires information on the natural environment of offshore wind power generation facilities and the surrounding underwater or sea surface.

### PTL 1

Japanese Patent Kokai Publication No. JP-P2019–104419A

### SUMMARY

The following analysis is provided by the inventors of the present invention.

Many fishermen have expressed oppositions to installation of offshore wind power generation equipment, fearing that it could lead to loss of fishing grounds and occurrences of underwater noise, tidal changes and reflected waves etc. during operation and thus in some cases the installation has not progressed. Further, even if monitoring is conducted after the installation of offshore wind power generation equipment, there are cases where an unintended ecosystem emerges, which makes it impossible to adequately assess the impact on the environment.

It is an object of the present invention to provide a server, a control method, and a program that contribute to making it possible to grasp and control condition(s) of fishing ground(s) that has changed due to installation of offshore wind power generation equipment.

According to a first aspect of the present invention, there can be provided a server comprising:

a marine environment information reception part that receives marine environment information detected by each sensor,

a marine environment information transmission part that transmits the received marine environment information to a control instruction generation apparatus,

a control instruction information reception part that receives marine environment control instruction information generated by the control instruction generation apparatus based on the transmitted marine environment information, and

a control instruction information transmission part that transmits the received marine environment control instruction information to each control apparatus.

According to a second aspect of the present invention, there can be provided a control method which causes a server to:

receive marine environment information detected by each sensor, transmit the received marine environment information to a control instruction generation apparatus,

receive marine environment control instruction information generated by the control instruction generation apparatus based on the transmitted marine environment information, and

transmit the received marine environment control instruction information to each control apparatus.

The present method is tied to a particular machine, namely a computer that executes the method described above.

According to a third aspect of the present invention, there can be provided a program which causes a server to execute:

a process of receiving marine environment information detected by each sensor,

a process of transmitting the received marine environment information to a control instruction generation apparatus,

a process of receiving marine environment control instruction information generated by the control instruction generation apparatus based on the transmitted marine environment information, and

a process of transmitting the received marine environment control instruction information to each control apparatus.

It should be noted that the program(s) can be stored in a computer-readable storage medium. The storage medium may be a non-transitory one such as a semiconductor memory, a hard disk, a magnetic recording medium, an optical recording medium, and the like. The present invention can also be embodied (realized) as a computer program product.

According to the present invention, there can be provided a server, a control method, and a program that contribute to making it possible to grasp and control condition(s) of fishing ground(s) that has changed due to installation of offshore wind power generation equipment.

### BRIEF DESCRIPTION OF DRAWINGS

FIG. 1 is a block diagram illustrating an example of configuration of a system including a server according to the present disclosure.

FIG. 2 is a block diagram illustrating another example of configuration of a system including a server according to the present disclosure.

FIG. 3 is a drawing illustrating an example of an environment to which a system including a server according to the present disclosure is applied.

FIG. 4 is a block diagram illustrating an example of configuration of a control instruction generation apparatus in a case where a system including a server according to the present disclosure performs an ocean current control.

FIG. 5 is a flow diagram illustrating an example of an ocean current control of a system including a server according to the present disclosure.

FIG. 6 is a block diagram illustrating an example of configuration of a control instruction generation apparatus in a case where a system including a server according to the present disclosure performs a water temperature control.

FIG. 7 is a diagram illustrating an example of an environment in a case where a system including a server according to the present disclosure is applied to a water temperature control.

FIG. 8 is a flow diagram illustrating an example of a water temperature control of a system including a server according to the present disclosure.

FIG. 9 is a flow diagram illustrating an operation of a control apparatus in a case of a water temperature control by a system including a server according to the present disclosure.

FIG. 10 is a block diagram illustrating another example of configuration of a system including a server according to the present disclosure.

FIG. 11 is a drawing illustrating configuration of a computer constituting a server according to the present disclosure.

### EXAMPLE EMBODIMENTS

In the present disclosure, a drawing(s) may be related to one or more example embodiments. In addition, each example embodiment described below can be appropriately combined with another/other example embodiment(s), and the present invention is not limited by each example embodiment.

First, an outline of an example embodiment will be described with reference to drawings. It should be noted that the reference signs added in this outline are given to each element for convenience as an example to facilitate understanding and are not intended to limit the present invention to the illustrated modes. Further, connection lines between blocks in the drawings etc. referred to in the following description can be both bidirectional and unidirectional. A unidirectional arrow schematically shows a main flow of a signal (data) and does not exclude bidirectionality.

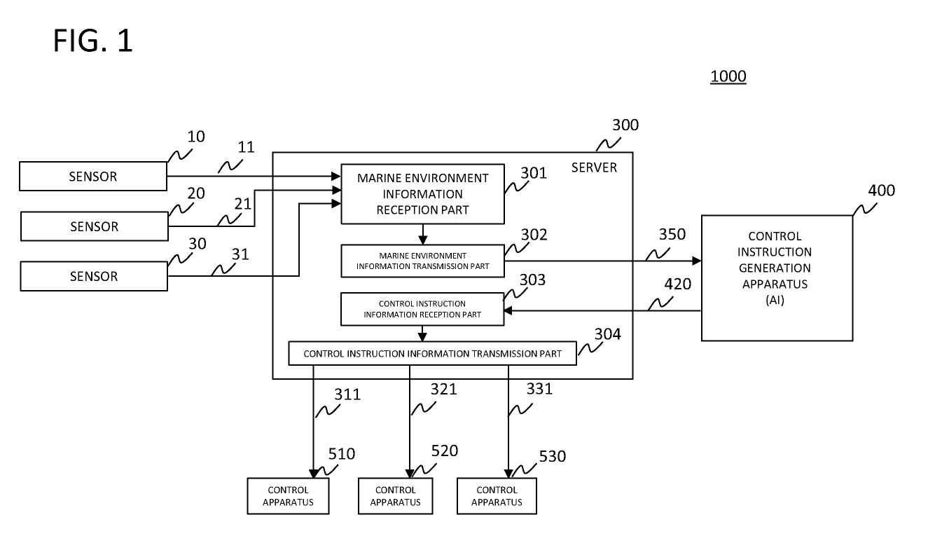

FIG. 1 is a block diagram illustrating an example of configuration of a system including a server according to the present disclosure. With reference to FIG. 1, the system 1000 includes sensors 10, 20, and 30, a server 300, a control instruction generation apparatus 400, and control apparatuses 510, 520, and 530. The server 300 includes a marine environment information reception part 301, a marine environment information transmission part 302, a control instruction information reception part 303, and a control instruction information transmission part 304.

The marine environment information reception part 301 receives marine environment information 11, 21, and 31 detected by each sensor 10, 20, and 30. The marine environment information transmission part 302 transmits the received marine environment information 11, 21, and 31 to the control instruction generation apparatus 400 via a connection 350. The control instruction information reception part 303 receives marine environment control instruction information 311 calculated by the control instruction generation apparatus 400 based on the transmitted marine environment information via a connection 420. The control instruction information transmission part 304 transmits the received marine environment control instruction information 311 to each control apparatus 510. Likewise, the control instruction information reception part 303 receives marine environment control instruction information 321 and 331 calculated by the control instruction generation apparatus 400 via the connection 420, and the control instruction information transmission part 304 transmits the marine environment control instruction information 321 and 331 to the control apparatuses 520 and 530, respectively.

It should be noted that the marine environment control instruction information 311 may be calculated by the control instruction generation apparatus 400 using AI (Artificial Intelligence) based on the transmitted marine environment information 11, 21, and 31.

According to an example embodiment of the present invention, there can be provided a server, a control method, and a program that contribute to making it possible to grasp and control condition(s) of fishing ground(s) that has changed due to installation of an offshore wind power generation apparatus(es).

Moreover, even if there is a favorable environment for offshore wind power generation and thus surplus electric power is generated, there are cases where operation is unilaterally suspended by the power company if the power cannot be fed into the transmission grid. However, according to an example embodiment of the present invention, surplus electric power can be utilized for grasping and controlling condition(s) of fishing ground(s) that has(have) changed due to the installation of an offshore wind power generation apparatus(es).

### First Example Embodiment

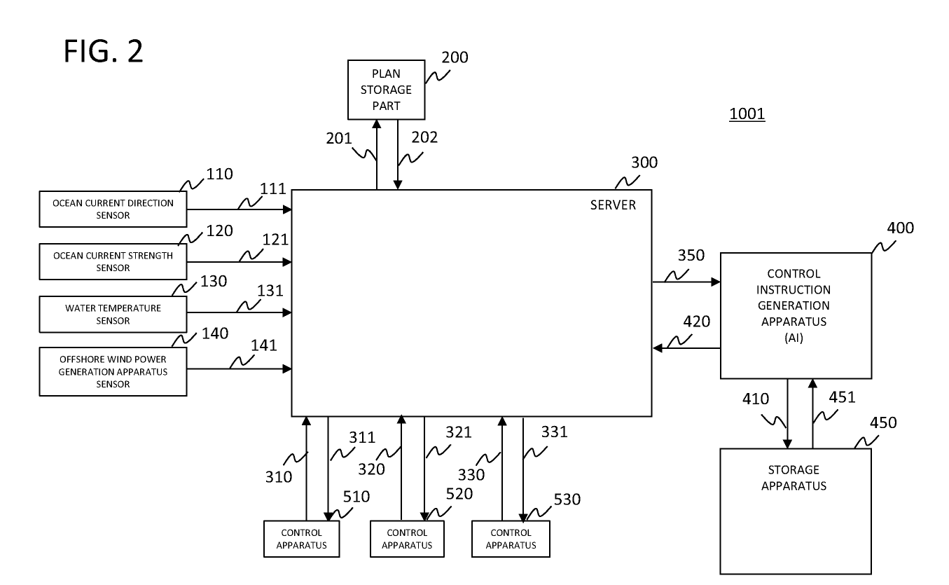

Next, a first example embodiment will be described in detail with reference to the drawings. FIG. 2 is a block diagram illustrating another example of configuration of a system including a server according to the present disclosure. In FIG. 2, elements denoted by the same reference signs as in FIG. 1 indicate the same elements. With reference to FIG. 2, a system 1001 includes an ocean current direction sensor 110, an ocean current strength sensor 120, a water temperature sensor 130, and an offshore wind power generation apparatus sensor 140 corresponding to the individual sensors 10, 20, and 30 in FIG. 1, and a plan storage part 200, a server 300, a control instruction generation apparatus 400, and control apparatuses 510, 520, and 530. The server 300 shown in FIG. 2 executes the functions of the marine environment information reception part 301, the marine environment information transmission part 302, the control instruction information reception part 303, and the control instruction information transmission part 304 included in the server 300 described with reference to FIG. 1. These functions may be executed by including the marine environment information reception part 301, the marine environment information transmission part 302, the control instruction information reception part 303, and the control instruction information transmission part 304, or alternatively, may be executed by software that comprehensively performs the functions of the marine environment information reception part 301, the marine environment information transmission part 302, the control instruction information reception part 303, and the control instruction information transmission part 304. The plan storage part 200 stores, as an example, a target value(s) 202 based on a plan for marine environment (for instance, a marine environment maintenance plan).

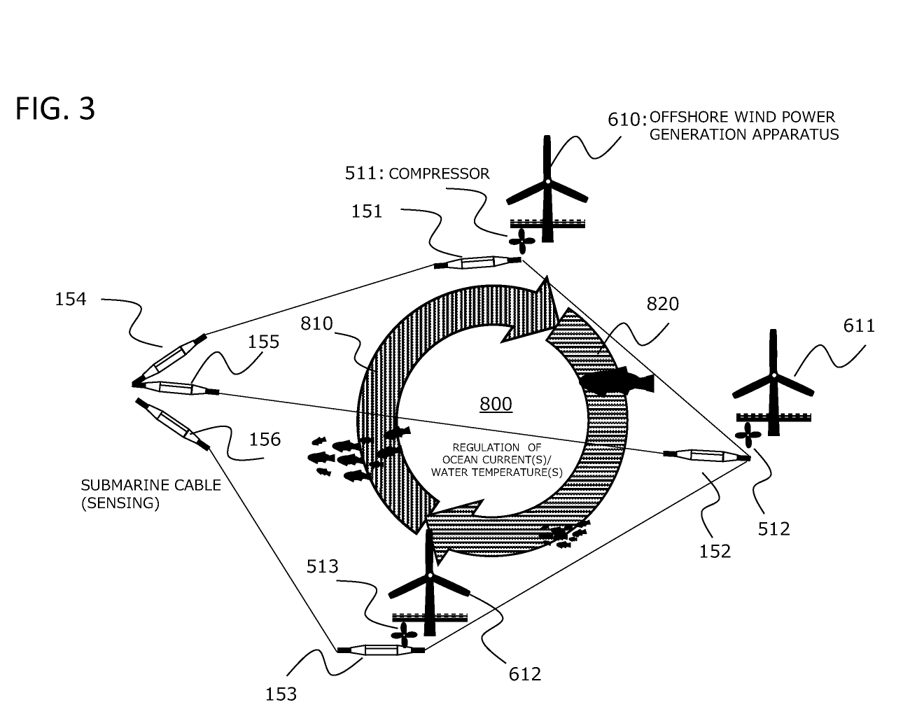

FIG. 3 is a drawing illustrating an example of an environment to which a system including a server according to the present disclosure is applied. With reference to FIG. 3, offshore wind power generation apparatuses 610, 611, and 612 are installed offshore, and the individual offshore wind power generation apparatuses 610, 611, and 612 are provided underwater with compressors 511, 512, and 513, respectively, as ocean current control apparatuses included in the control apparatuses 510. It should be noted that the compressors 511, 512, and 513 respectively correspond to the control apparatus 510 in FIG. 2. Further, sensors 151, 152, 153, 154, 155, and 156 are installed underwater, and the sensors 151, 152, 153, 154, 155, and 156 may respectively include the ocean current direction sensor 110, the ocean current strength sensor 120, and the water temperature sensor 130 in FIG. 2. The offshore wind power generation apparatus sensor 140 may be installed in each of the offshore wind power generation apparatuses 610, 611, and 612. The compressors 511, 512, and 513 may be operated using electric power generated by the individual offshore wind power generation apparatuses 610, 611, and 612, for instance, by using stored surplus electricity.

With reference to FIG. 3, an ocean current(s) in a target sea area 800 is(are) controlled by ocean currents 810 and 820 generated by the compressors 511, 512, and 513. At this time, in a case where a temperature control that raises or lowers an ocean current temperature(s) is also performed, each of the ocean currents 810 and 820 generated by the compressors 511, 512, and 513 may be heated or cooled to control a temperature(s) of the ocean current(s), thereby controlling a temperature of the sea area 800. It should be noted that the temperatures of the ocean currents 810 and 820 may be different from each other.

Upon receiving marine environment information that includes sensor actual values 111, 121, and 131 detected (acquired) by the ocean current direction sensor 110, the ocean current strength sensor 120, and the water temperature sensor 130 with respect to a marine environment(s) around the offshore wind power generation apparatuses 610, 611, and 612, as well as target values 202 based on a plan(s) for a marine environment (for instance, a marine environment maintenance plan), the server 300 transmits the marine environment information that includes the sensor actual values 111, 121, and 131 and the target values 202 to the control instruction generation apparatus 400 via a connection 350. The server 300 receives, via a connection 420, marine environment control instruction information 311 that includes control amount(s) calculated by the control instruction generation apparatus 400, in order to bring the sensor actual values 111, 121, and 131 closer to the target values 202 by comparing the sensor actual values 111, 121, and 131 with the target values 202. The server 300 transmits the received marine environment control instruction information 311 to the compressors 511, 512, and 513 corresponding to the control apparatus 510.

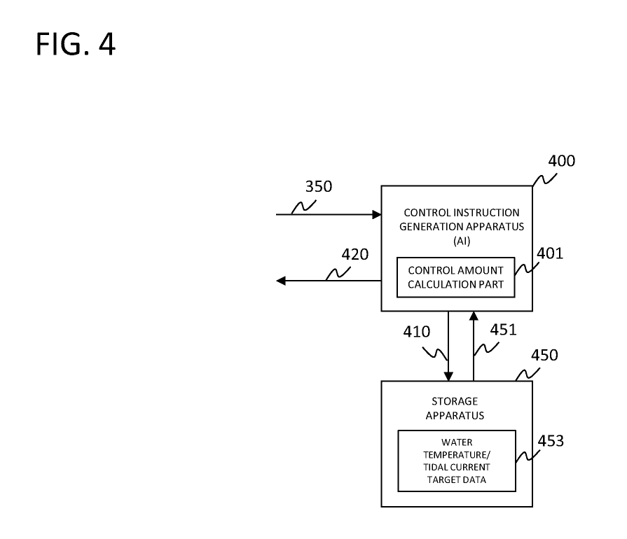

FIG. 4 is a block diagram illustrating an example of configuration of a control instruction generation apparatus in a case where a system including a server according to the present disclosure performs an ocean current control. With reference to FIG. 4, the control instruction generation apparatus 400 includes a control amount calculation part 401. A storage apparatus 450 receives, via a connection 410, water temperature/tidal current target data 453, which are the target values 202 received by the control instruction generation apparatus 400 from the server 300, and stores them. When calculating control amount(s), the control instruction generation apparatus 400 reads out the water temperature/tidal current target data 453, which are the stored target values 202, via a connection 451 and uses the data.

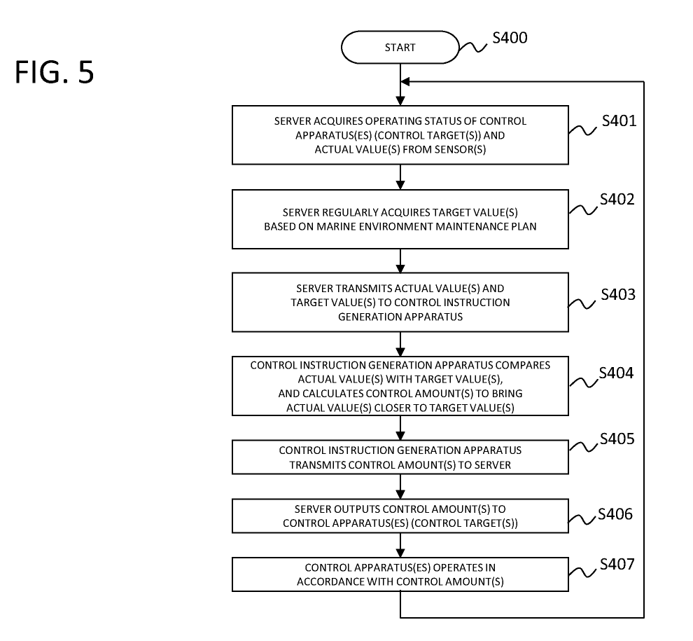

Next, an operation of an ocean current control will be described in detail with reference to a drawing. FIG. 5 is a flow diagram illustrating an example of an ocean current control by a system including a server according to the present disclosure. With reference to FIG. 5, the process starts in step S400.

Next, in step S401, the server 300 acquires an operating status of the control apparatus (control target) 510 and the sensor actual values 111, 121, and 131 from each of the ocean current direction sensor 110, the ocean current strength sensor 120, and the water temperature sensor 130.

Next, in step S402, the server 300 regularly acquires target values 202 based on a marine environment maintenance plan from the plan storage part 200.

Next, in step S403, the server 300 transmits the sensor actual values 111, 121, and 131 and the target values 202 to the control instruction generation apparatus 400.

Next, in step S404, the control instruction generation apparatus 400 compares the sensor actual values 111, 121, and 131 with the target values 202, and calculates control amount(s) for the control apparatus 510 to bring the sensor actual values 111, 121, and 131 closer to the target values 202.

Next, in step S405, the control instruction generation apparatus 400 transmits marine environment control instruction information 311 that includes the control amount(s) to the server 300.

Next, in step S406, the server 300 outputs the marine environment control instruction information 311 including the control amount(s) to the compressors 511, 512, and 513 corresponding to the control apparatus (control target) 510.

Next, in step S407, the compressors 511, 512, and 513 corresponding to the control apparatus 510 operate in accordance with the control amount(s) in the marine environment control instruction information 311.

Next, the process returns to the step S401, and the above steps are repeated. As a result, the ocean current(s) in the target sea area 800 can be controlled. As described above, by additionally raising or lowering the temperature(s) of the ocean current(s), it becomes possible to control direction(s) and strength(s) of the ocean current(s) in the target sea area 800, as well as increase(s) or decrease(s) in the water temperature(s) thereof.

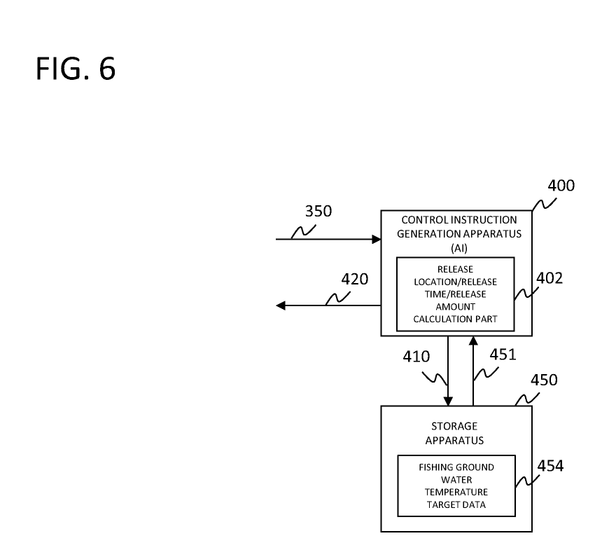

Next, a control of lowering a water temperature of a target sea area 800 (fishing ground) will be described with reference to the drawings. FIG. 6 is a block diagram illustrating an example of configuration of a control instruction generation apparatus in a case where a system including a server according to the present disclosure performs a water temperature control. With reference to FIG. 6, the control instruction generation apparatus 400 includes a release location/release time/release amount calculation part 402. The control instruction generation apparatus 400 receives a target value(s) 202 acquired by the server 300 from the plan storage part 200, and the storage apparatus 450 receives, via the connection 410, fishing ground water temperature target data 454, which are target value(s) 202 received by the control instruction generation apparatus 400, and stores the data. When calculating control amount(s), the control instruction generation apparatus 400 reads out the fishing ground water temperature target data 454, which are the stored target value(s) 202, via the connection 451 and uses the data.

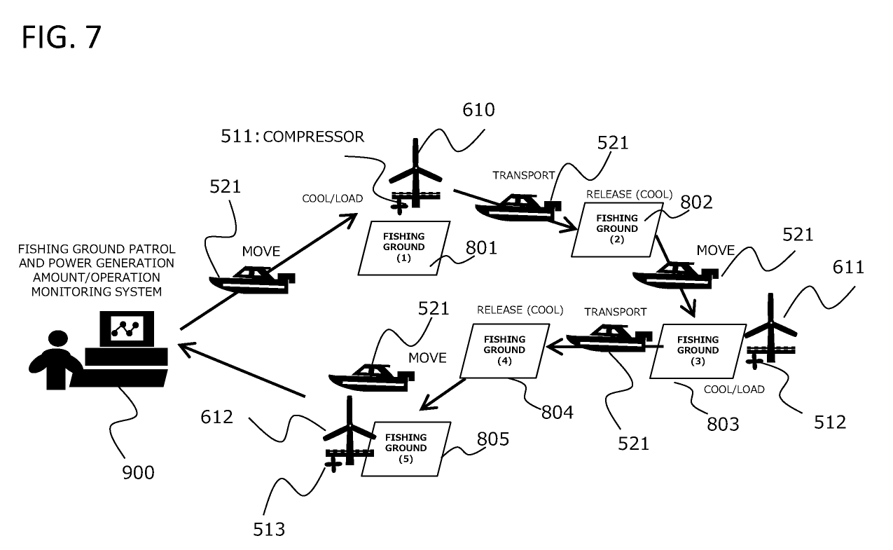

FIG. 7 is a diagram illustrating an example of an environment in a case where a system including a server according to the present disclosure is applied to a water temperature control. With reference to FIG. 7, the offshore wind power generation apparatuses 610, 611, and 612 are installed offshore. It is assumed that the compressors 511, 512, and 513 are installed at the offshore wind power generation apparatuses 610, 611, and 612, respectively. The control to decrease a water temperature is performed by cooling seawater by releasing (loaded) cooling water injected into a watercraft 521 as an example of the control apparatus 520 into a fishing ground(s) requiring the cooling. It should be noted that the cooling water may be generated from seawater by using electric power generated by the offshore wind power generation apparatuses 610, 611, and 612, for instance, using stored surplus electric power to perform compression, heat radiation, and expansion of the seawater by the compressors 511, 512, and 513. In a case where a control to increase a water temperature is performed, the water may be heated by using a heater.

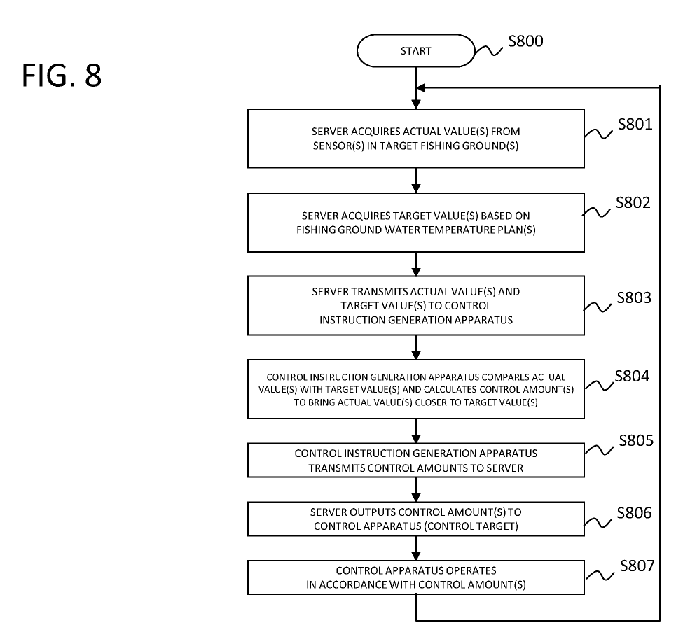

Next, an operation of a water temperature control will be described in detail with reference to a drawing. FIG. 8 is a flow diagram illustrating an example of a water temperature control by a system including a server according to the present disclosure. With reference to FIG. 8, the process starts in step S800.

Next, in step S801, the server 300 acquires a sensor actual value 131 of water temperature from the water temperature sensor 130 in the target fishing ground. The water temperature sensor 130 may be included in each of the sensors 151, 152, 153, 154, 155, and 156 shown in FIG. 3.

Next, in step S802, the server 300 acquires a target value 202 based on a fishing ground water temperature plan from the plan storage part 200 shown in FIG. 2.

Next, in step S803, the server 300 transmits the sensor actual value 131 and the target value 202 to the control instruction generation apparatus 400.

Next, in step S804, the control instruction generation apparatus 400 compares the sensor actual value 131 with the target value 202 and calculates control amount(s) (for instance, a release location/release time/release amount) to bring the sensor actual value 131 closer to the target value(s) 202.

Next, in step S805, the control instruction generation apparatus 400 transmits, to the server 300, marine environment control instruction information 311 including the control amount(s) (for instance, a release location/release time/release amount).

Next, in step S806, the server 300 outputs the marine environment control instruction information 311 including the control amount(s) to the watercraft 521 corresponding to the control apparatus (control target) 520.

Next, in step S807, the watercraft 521 corresponding to the control apparatus 520 performs an operation of releasing cooling water in accordance with the control amount(s) (for instance, a release location/release time/release amount) in the marine environment control instruction information 311.

Next, the process returns to the step S801, and the above steps are repeated. As an example, the watercraft 521 travels sequentially through fishing grounds (1) to (5) shown in FIG. 7 and performs an operation to release cooling water in accordance with the control amount(s) (for instance, a release location/release time/release amount). As a result, the water temperature(s) of the target sea area 800 can be controlled.

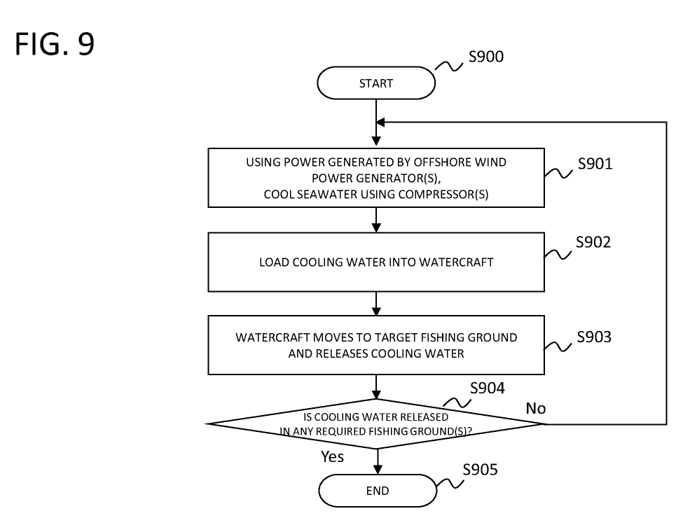

Next, an operation of a watercraft 521 corresponding to the control apparatus 520 will be described in detail with reference to a drawing. FIG. 9 is a flow diagram illustrating an operation of a control apparatus in a case of a water temperature control by a system including a server according to the present disclosure. With reference to FIG. 9, the process starts in step S900.

Next, in step S901, seawater is cooled using the compressors 511 and 512 of the offshore wind power generation apparatus 610.

Next, in step S902, cooling water cooled using the compressor 511 is loaded into the watercraft 521 corresponding to the control apparatus 520.

Next, in step S903, the watercraft 521 moves to the target fishing ground (2) shown in FIG. 7 and releases the cooling water.

Next, in step S904, it is determined whether or not the watercraft has released cooling water in any required fishing ground(s) (i.e. in any fishing ground(s) for which cooling is required). If there remains a fishing ground(s) for which release of cooling water is required (No in step S904), the process returns to the step S901, and the same steps are repeated at a next fishing ground(s).

In other words, in step S902, cooling water cooled using the compressor 512 is loaded into the watercraft 521 corresponding to the control apparatus 520. Next, in step S903, the watercraft 521 moves to the target fishing ground (4) shown in FIG. 7 and releases the cooling water.

If there is no fishing ground for which release of cooling water is required (Yes in step S904), the process ends in step S905.

It should be noted that each of the steps described above may be monitored by a fishing ground patrol and power generation amount/operation monitoring system 900.

Further, the offshore wind power generation apparatus sensor 140 shown in FIG. 2 may acquire operating statuses 141 of the offshore wind power generation apparatuses 610, 611, and 612, and the server 300 may determine, based on the operating statuses, whether or not maintenance of the offshore wind power generation apparatuses 610, 611, and 612 is required. The maintenance may be performed through means that actually moves along a (specified) route and do checking as the control apparatus 530. It should be noted that a skilled person(s) may board the checking means to do checking.

As described above, according to the first example embodiment of the present invention, there can be provided a server, a control method, and a program that contribute to making it possible to grasp and control condition(s) of fishing ground(s) that has changed due to installation of an offshore wind power generation apparatus(es).

Further, according to the first example embodiment of the present invention, it is possible to grasp maintenance timing of an offshore wind power generation apparatus(es), and when maintenance is required, a skilled person(s) can be arranged to perform visual inspection.

### Second Example Embodiment

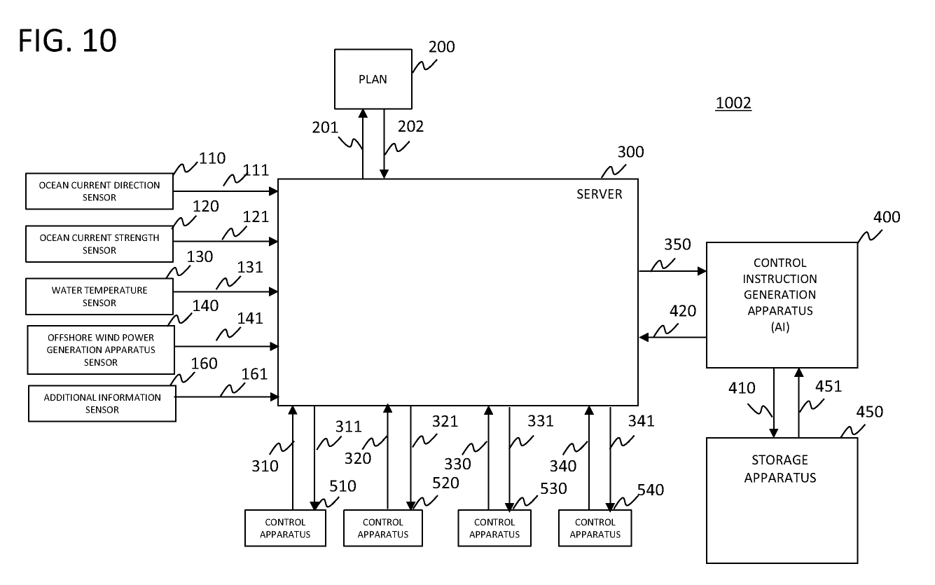

Next, a second example embodiment will be described in detail with reference to a drawing. FIG. 10 is a block diagram illustrating another example of configuration of a system including a server according to the present disclosure. In FIG. 10, elements denoted by the same reference signs as in FIG. 2 indicate the same elements. With reference to FIG. 10, a system 1002 includes an ocean current direction sensor 110, an ocean current strength sensor 120, a water temperature sensor 130, and an offshore wind power generation apparatus sensor 140, which are also shown in FIG. 2, as well as an additional information sensor(s) 160, a server 300, a control instruction generation apparatus 400, and control apparatuses 510, 520, 530, and 540. The server 300 shown in FIG. 10 executes the functions of the marine environment information reception part 301, the marine environment information transmission part 302, the control instruction information reception part 303, and the control instruction information transmission part 304 included in the server 300 described with reference to FIG. 1. These functions may be executed by including the marine environment information reception part 301, the marine environment information transmission part 302, the control instruction information reception part 303, and the control instruction information transmission part 304, or alternatively, may be configured by software that comprehensively performs the functions of the marine environment information reception part 301, the marine environment information transmission part 302, the control instruction information reception part 303, and the control instruction information transmission part 304.

The additional information sensor(s) 160 shown in FIG. 10 may include at least one of a soil property (composition, shape) sensor, an ambient light (sunlight duration, shadow position) sensor, an ambient sound (noise) sensor, a food chain (biological species, quantity) sensor, a microorganism sensor, a water quality (composition, plankton amount, red tide, etc.) sensor, and a catch quantity (type, amount, quality (size, weight)) sensor. Further, the control apparatus 540 may be of configuration making it possible to perform a control of soil property/properties (addition or removal of component(s), shape change), ambient light (irradiation of artificial light, formation of shading), ambient sound (addition of canceling sound), microorganism(s) (addition or removal), and water quality (removal of impurity/impurities) based on marine environment control instruction information 341 including calculated control amount(s) for marine environment information 161 detected by the soil property sensor, the ambient light sensor, the ambient sound sensor, the food chain sensor, the microorganism sensor, and the water quality sensor described above. The formation of shading may be implemented by, for instance, a shielding plate(s) or the like that is normally closed and opened when shading needs to be formed.

As described above, according to the second example embodiment of the present invention, there can be provided a server, a control method, and a program that contribute to making it possible to grasp and control condition(s) of fishing ground(s) that has changed due to installation of an offshore wind power generation apparatus(es).

While each example embodiment of the present invention has been described, it is to be understood that the present invention is not limited to the above-mentioned example embodiments and that further modifications, replacements, and adjustments may be added within a scope which does not depart from the basic technical concept of the present invention. For instance, the network configuration, the configuration of each element, and the expression of each message shown in each drawing are examples to facilitate understanding of the present invention and are not limited to the configurations shown in the drawings. Further, “A and/or B” means at least one of A and B.

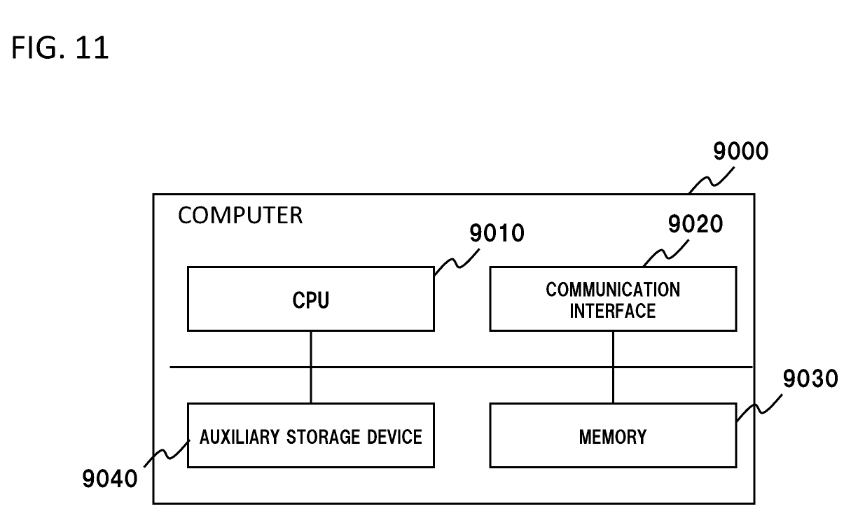

The procedures described in the one example embodiment, the first example embodiment and the second example embodiment as described above can be implemented by a program causing a computer (9000 in FIG. 11) that functions as each part of a server according to the present invention to achieve the function of each part of the server. Such a computer is exemplified as configuration which includes a CPU (Central Processing Unit) 9010, a communication interface 9020, a memory 9030, and an auxiliary storage device 9040 in FIG. 11. That is, the CPU 9010 in FIG. 11 may be made to execute a program(s) that controls each part of the server, and perform an update process of each calculation parameter stored in the auxiliary storage device 9040 or the like.

The memory 9030 is a RAM (Random Access Memory), a ROM (Read-Only Memory), or the like.

In other words, each part (each processing means or function) of the server described in the one example embodiment, the first example embodiment and the second example embodiment as described above can be realized by a computer program causing the processor of the computer to execute each of the processes described above using the hardware thereof.

### Supplementary Notes

Finally, preferred modes (supplementary notes) of the present invention will be summarized.

### Mode 1

A server may comprise a marine environment information reception part that receives marine environment information detected by each sensor.

A server may comprise a marine environment information transmission part that transmits the received marine environment information to a control instruction generation apparatus.

A server may comprise a control instruction information reception part that receives marine environment control instruction information generated by the control instruction generation apparatus based on the transmitted marine environment information.

A server may comprise a control instruction information transmission part that transmits the received marine environment control instruction information to each control apparatus.

### Mode 2

In the server according to Mode 1, it is preferable that the marine environment information includes a sensor actual value(s) detected by said each sensor with respect to a marine environment around offshore wind power generation apparatus(es).

In the server according to Mode 1, it is preferable that the marine environment information transmission part transmits, to the control instruction generation apparatus, the marine environment information and a target value(s) based on a plan(s) for the marine environment.

In the server according to Mode 1, it is preferable that the marine environment control instruction information includes a control amount(s) calculated by the control instruction generation apparatus in order to bring the sensor actual value(s) closer to the target value(s) by comparing the sensor actual value(s) with the target value(s).

### Mode 3

In the server according to Mode 1, it is preferable that said each sensor includes an ocean current direction sensor(s), an ocean current strength sensor(s), and a water temperature sensor(s).

### Mode 4

In the server according to Mode 1, it is preferable that the control apparatus(es) include(s) an ocean current control apparatus(es).

### Mode 5

In the server according to Mode 4, it is preferable that the ocean current control apparatus(es) include(s) a compressor(s).

### Mode 6

In the server according to Mode 1, it is preferable that the marine environment control instruction information is calculated by the control instruction generation apparatus using AI (Artificial Intelligence).

### Mode 7

In the server according to Mode 1, it is preferable that said each sensor further includes at least one of a soil property sensor, an ambient light sensor, an ambient sound sensor, a microorganism sensor, and a water quality sensor.

### Mode 8

In the server according to Mode 1, it is preferable that the server further acquires an operating status(es) from the offshore wind power generation apparatus(es) and determines whether or not maintenance of the offshore wind power generation apparatus(es) is required.

### Mode 9

In a control method, a server may receive marine environment information detected by each sensor.

In a control method, a server may transmit the received marine environment information to a control instruction generation apparatus.

In a control method, a server may receive marine environment control instruction information generated by the control instruction generation apparatus based on the transmitted marine environment information.

In a control method, a server may transmit the received marine environment control instruction information to each control apparatus.

### Mode 10

A program may cause a server to execute a process of receiving marine environment information detected by each sensor.

A program may cause a server to execute a process of transmitting the received marine environment information to a control instruction generation apparatus.

A program may cause a server to execute a process of receiving marine environment control instruction information generated by the control instruction generation apparatus based on the transmitted marine environment information.

A program may cause a server to execute a process of transmitting the received marine environment control instruction information to each control apparatus.

It should be noted that Modes 9 and 10 described above can be extended into Modes 2 to 7 in the same manner as Mode 1.

Further, the disclosure of the Patent Literature cited above is incorporated herein in its entirety by reference thereto. It is to be noted that it is possible to modify or adjust the example embodiments or examples within the scope of the whole disclosure of the present invention (including the Claims) and based on the basic technical concept thereof. Further, it is possible to variously combine or select a wide variety of the disclosed elements (including the individual elements of the individual claims, the individual elements of the individual example embodiments or examples, and the individual elements of the individual figures) within the scope of the whole disclosure of the present invention. That is, it is self-explanatory that the present invention includes any types of variations and modifications to be done by a skilled person according to the whole disclosure including the Claims, and the technical concept of the present invention. Particularly, any numerical ranges disclosed herein should be interpreted that any arbitrary values or subranges falling within the disclosed ranges are also disclosed even without explicit recital thereof. In addition, using some or all of the disclosed elements in each literature cited above as necessary in combination with the elements described herein as part of the disclosure of the present invention in accordance with the gist of the present invention shall be considered to be included in the disclosed elements of the present application.

### REFERENCE SIGNS LIST

10, 20, 30 sensor

110 ocean current direction sensor

120 ocean current strength sensor

130 water temperature sensor

140 offshore wind power generation apparatus sensor

151, 152, 153, 154, 155, 156 sensor

160 additional information sensor

200 plan storage part

300 server

301 marine environment information reception part

302 marine environment information transmission part

303 control instruction information reception part

304 control instruction information transmission part

400 control instruction generation apparatus

401 control amount calculation part

402 release location/release time/release amount calculation part

410 connection

450 storage apparatus

451 connection

453 water temperature/tidal current target data

454 fishing ground water temperature target data

510, 520, 530, 540 control apparatus

511, 512, 513 compressor

521 watercraft

610, 611, 612 offshore wind power generation apparatus

800 sea area

801 fishing ground (1)

802 fishing ground (2)

803 fishing ground (3)

804 fishing ground (4)

805 fishing ground (5)

810, 820 ocean current

900 fishing ground patrol and power generation amount/operation monitoring system

1000, 1001, 1002 system

9000 computer

9010 CPU

9020 communication interface

9030 memory

9040 auxiliary storage device

What is claimed is:

1. A server, comprising:
a marine environment information reception part that receives marine environment information detected by each sensor;
a marine environment information transmission part that transmits the received marine environment information to a control instruction generation apparatus;
a control instruction information reception part that receives marine environment control instruction information generated by the control instruction generation apparatus based on the transmitted marine environment information; and
a control instruction information transmission part that transmits the received marine environment control instruction information to each control apparatus.

2. The server according to claim 1, wherein
the marine environment information includes a sensor actual value detected by said each sensor with respect to a marine environment around an offshore wind power generation apparatus,
the marine environment information transmission part transmits, to the control instruction generation apparatus, the marine environment information and a target value based on a plan for the marine environment, and
the marine environment control instruction information includes a control amount calculated by the control instruction generation apparatus in order to bring the sensor actual value closer to the target value by comparing the sensor actual value with the target value.

3. The server according to claim 1, wherein said each sensor includes an ocean current direction sensor, an ocean current strength sensor, and a water temperature sensor.

4. The server according to claim 1, wherein the control apparatus includes an ocean current control apparatus.

5. The server according to claim 4, wherein the ocean current control apparatus includes a compressor.

6. The server according to claim 1, wherein the marine environment control instruction information is calculated by the control instruction generation apparatus using AI (Artificial Intelligence).

7. The server according to claim 1, wherein said each sensor further includes at least one of a soil property sensor, an ambient light sensor, an ambient sound sensor, a microorganism sensor, and a water quality sensor.

8. The server according to claim 2, further acquiring an operating status from the offshore wind power generation apparatus and determining whether or not maintenance of the offshore wind power generation apparatus is required.

9. A control method, comprising:
causing a server to:
receive marine environment information detected by each sensor;
transmit the received marine environment information to a control instruction generation apparatus;
receive marine environment control instruction information generated by the control instruction generation apparatus based on the transmitted marine environment information; and
transmit the received marine environment control instruction information to each control apparatus.

10. A computer-readable, non-transitory program recording medium recording a program, causing a server to execute:
a process of receiving marine environment information detected by each sensor;
a process of transmitting the received marine environment information to a control instruction generation apparatus;
a process of receiving marine environment control instruction information generated by the control instruction generation apparatus based on the transmitted marine environment information; and
a process of transmitting the received marine environment control instruction information to each control apparatus.

11. The control method according to claim 9, further comprising:
causing the server to transmit, to the control instruction generation apparatus, the marine environment information which includes a sensor actual value detected by said each sensor with respect to a marine environment around an offshore wind power generation apparatus and a target value based on a plan for the marine environment,
wherein the marine environment control instruction information includes a control amount calculated by the control instruction generation apparatus in order to bring the sensor actual value closer to the target value by comparing the sensor actual value with the target value.

12. The control method according to claim 9, wherein the marine environment control instruction information is calculated by the control instruction generation apparatus using AI.

13. The control method according to claim 11, further comprising:
causing the server to:
acquire an operating status from the offshore wind power generation apparatus and
determine whether or not maintenance of the offshore wind power generation apparatus is required.

14. The control method according to claim 9, wherein the control apparatus includes an ocean current control apparatus.

15. The control method according to claim 14, wherein the ocean current control apparatus includes a compressor.

16. The recording medium according to claim 10, further causing
the server to execute:
a process of transmitting, to the control instruction generation apparatus, the marine environment information which includes a sensor actual value detected by said each sensor with respect to a marine environment around an offshore wind power generation apparatus and a target value based on a plan for the marine environment,
wherein the marine environment control instruction information includes a control amount calculated by the control instruction generation apparatus in order to bring the sensor actual value closer to the target value by comparing the sensor actual value with the target value.

17. The recording medium according to claim 10, wherein the marine environment control instruction information is calculated by the control instruction generation apparatus using AI.

18. The recording medium according to claim 16,
further causing the server to execute:
a process of acquiring an operating status from the offshore wind power generation apparatus and
a process of determining whether or not maintenance of the offshore wind power generation apparatus is required.

19. The recording medium according to claim 10, wherein the control apparatus includes an ocean current control apparatus.

20. The recording medium according to claim 19, wherein the ocean current control apparatus includes a compressor.
